(19) United States
(12) Patent Application Publication
(10) Pub. No.: US 2002/0091583 A1
(43) Pub. Date: Jul. 11, 2002

(54) Method for selling consumer goods

(76) Inventor: Ichiro Koyama, Kawasaki (JP)

Correspondence Address: STAAS & HALSEY LLP, 700 11TH STREET, NW, SUITE 500, WASHINGTON, DC, 20001, US

(21) Appl. No.: 09/873,284

(22) Filed: Jun. 5, 2001

(30) Foreign Application Priority Data
Jan. 11, 2001 (JP) 2001-003283

(51) Int. Cl. G06F 17/60

(52) U.S. Cl. 705/26

(57) ABSTRACT

At the Web site provided by a server machine, a customer designates the desired goods and packaging sheet for wrapping the goods. The customer can select the desired packaging sheet among those provided by retailers. The selection of a packaging sheet means the selection of the retailer which provides the packaging sheet. Then, the designated goods are delivered to the delivery destination designated by the customer with the goods being wrapped in the designated packaging sheet.

### BACKGROUND OF THE INVENTION

1. Field of the Invention

The present invention relates to a method for selling goods provided by retailers to end customers.

2. Description of the Related Art

Conventionally, wholesalers who deal with retailers such as department stores and shops purchase goods produced by manufacturers, and sell the purchased goods to the retailers.

Usually, goods are delivered from manufacturers through wholesalers to retailers. In some cases, goods for gifts such as Christmas presents are distributed via channels different from usual ones. More specifically, when a customer places an order for goods and designates the delivery destination of same goods with a retailer, the retailer informs the wholesaler of the receipt of the order for the goods and the designated delivery destination of same goods. Then, the wholesaler requests a freight agency to deliver the goods to the designated destination. If the wholesaler stocks the goods, the stock is delivered to the destination. On the other hand, if the wholesaler does not stock them, the goods stocked by the manufacturer are delivered to the destination. In terms of accounting, the wholesaler purchases the goods from the manufacturer and sells them to the retailer, which in turn sells them to the end customer.

As described above, customers select retailers and go to the retailers to place orders for goods. Accordingly, a customer has to go to the retailers, if he or she want to buy gifts from different retailers to send them to respective destinations. It is very inconvenient for the customers.

### SUMMARY OF THE INVENTION

It is therefore an object of the present invention to provide a method for selling goods which provides an improved convenience.

The method for selling goods according to the present invention employs the following configuration to solve the aforementioned problems.

That is, the method for selling goods, comprising: a step of storing packaging material data which includes information indicating a packaging material and retailer information indicating a retailer providing the packaging material, as well as goods data which includes goods description information describing goods for sale; a step of sending offering data which includes the goods description information in said goods data and the information indicating a packaging material in said packaging material data to a customer; a step of receiving designation data which includes goods designation information designating goods the customer desires to buy and packaging material designation information designating a packaging material selected by the customer; a step of specifying retailer information corresponding to the packaging material indicated by the packaging material designation information in the designation data received in said receiving step, based on said packaging material data; and a step of generating order data which includes the specified retailer information, customer information indicating the customer, and the goods designation information in the designation data received in said receiving step.

According to the aforementioned method for selling goods, the customer can select goods referring to the goods description information and designate a packaging material referring to the information indicating the packaging material. The designation of the packaging material means the designation of the retailer which provides the packaging material. Thus, the customer can buy the desired goods wrapped in the desired packaging material provided by the desired retailer. It should be noted that the packaging material can be either of paper or other material. In addition, the packaging material can be such as to wrap the whole goods or to be affixed to part of the goods.

### BRIEF DESCRIPTION OF THE DRAWINGS

The invention will be described below in detail with reference to the accompanying drawings, in which:

FIG. 1 shows an overview of a system including a server machine according to an embodiment of the present invention;

FIG. 2 is a view showing the architecture of a server machine according to an embodiment of the present invention;

FIG. 3 is a schematic view showing the structure of a packaging sheet database;

FIG. 4 is a schematic view showing the structure of a goods database;

FIG. 5 is a schematic view showing the structure of a customer database;

FIG. 6 is a schematic view showing the structure of an order database;

FIG. 7 is a flowchart showing a goods sale process;

FIG. 8 is a schematic view showing a goods list page;

FIG. 9 is a schematic view showing a goods information page;

FIG. 10 is a schematic view showing a shopping cart page;

FIG. 11 is a schematic view showing a delivery setting page;

FIG. 12 is a schematic view showing a packaging sheet list page;

FIG. 13 is a schematic view showing a payment mode designation page;

FIG. 14 is a schematic view showing a statistics Web page;

FIG. 15 is a schematic view showing a statistics Web page;

FIG. 16 is a schematic view showing a statistics Web page; and

FIG. 17 is a schematic view showing a statistics Web page.

### DETAILED DESCRIPTION OF THE PREFERRED EMBODIMENTS

The present invention will be explained below with reference to the accompanying drawings in accordance with the embodiments.

<Overall Configuration>

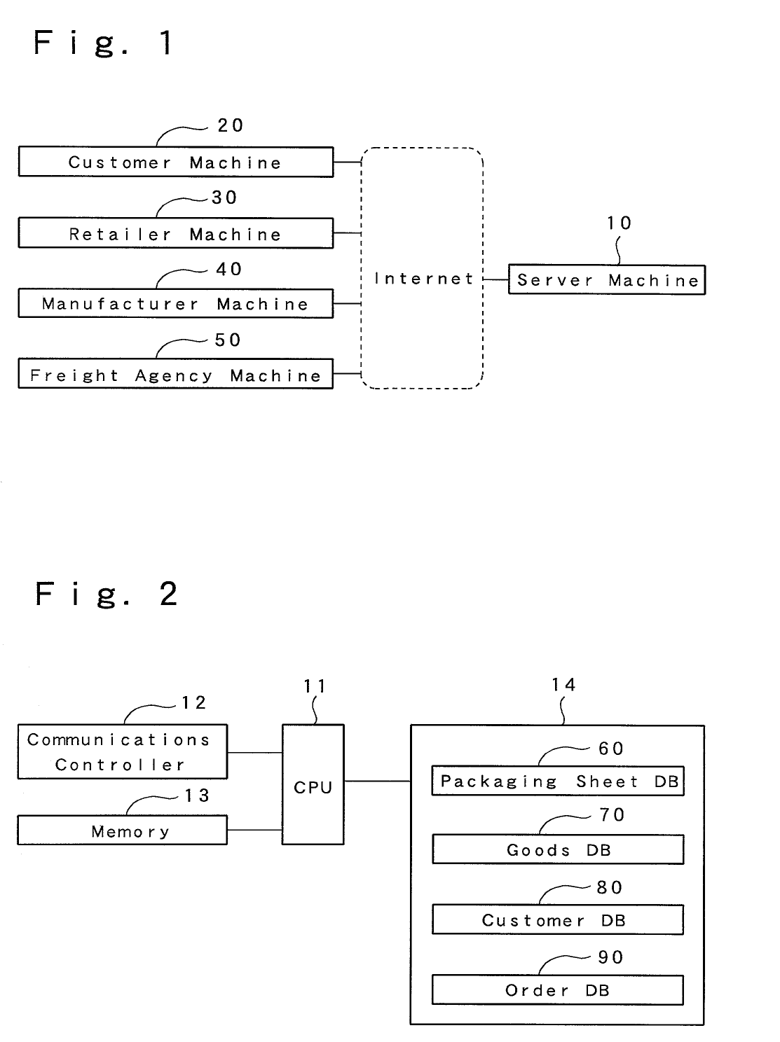

FIG. 1 illustrates an overview of a system including a server machine 10 according to an embodiment of the present invention. The server machine 10 is operated by a wholesaler. In addition, the server machine 10 is connected via the Internet to customer machines 20, retailer machines 30, manufacturer machines 40, and a freight agency machine 50, respectively. A plurality of customer machines 20, retailer machines 30, and manufacturer machines 40 are connected to the server machine 10 although only each one of them is shown in FIG. 1. The customer machines 20 are operated by the end customers. The retailer machines 30, manufacturer machines 40, and a freight agency machine 50, are operated by retailers, manufacturers, and a freight agency, respectively.

The customer machines 20, the retailer machines 30, the manufacturer machines 40, and the freight agency machine 50 comprise ordinary personal computers or work stations, each machine having a CPU, a monitor, a keyboard, a mouse, and a storage device storing a WWW (World Wide Web) browser program and a mailer program.

<Architecture of the Server Machine>

The server machine 10 comprises a high-performance computer. FIG. 2 illustrates the architecture of the server machine 10. The server machine 10 has a CPU 11, and a communication controller 12, a memory 13, and a hard disk drive unit (HDD) 14, which are connected to the CPU 11, respectively. The communication controller 12 is connected over the Internet to the customer machines 20, the retailer machines 30, the manufacturer machines 40, and the freight agency machine 50, respectively.

The HDD 14 stores an operating system and application programs. The operating system has a kernel for system management, and provides API (Application Program Interface) for the application programs. With at least part of the operating system being expanded on the memory 13, the CPU 11 operates in accordance with the code of the operating system.

On the other hand, the application programs invoke functions of the operating system using the API to perform predetermined processing. The application programs include a WWW server program, and a mailer program.

In addition, Web data which is used by the WWW server program is stored in the HDD 14. The Web data includes programs described in a variety of script languages. Furthermore, CGI (Common Gateway Interface) programs used by the WWW server program is stored in the HDD 14. The WWW server program in the server machine 10 is executed associated with WWW browser programs in the customer machines 20 or the retailer machines 30 to display Web pages based on the Web data on their monitors.

As shown in FIG. 2, the HDD 14 of the server machine 10 also stores a packaging sheet database 60, a goods database 70, a customer database 80, and an order database 90.

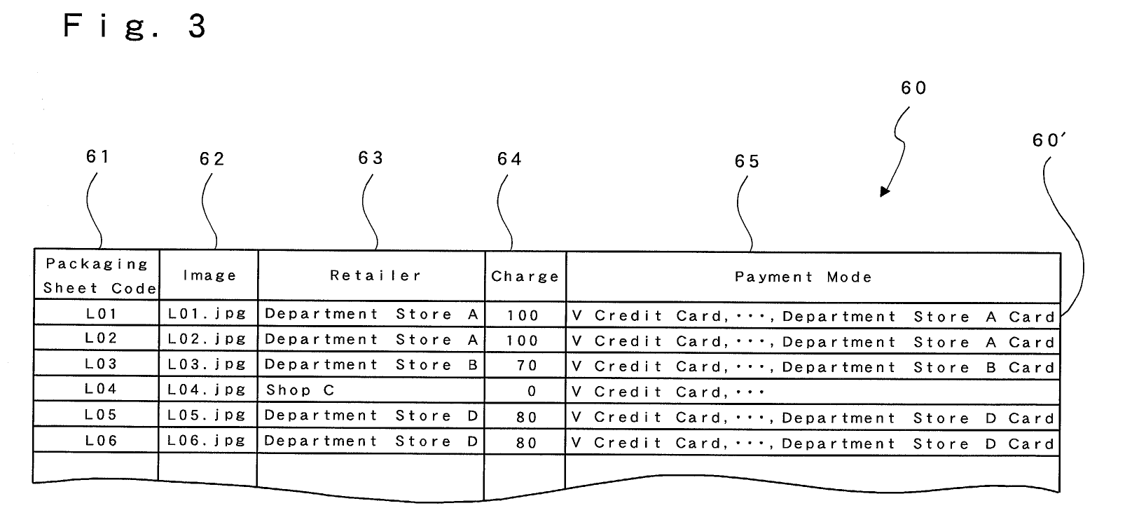

It should be noted that retailers provide their own specially designed packaging sheets (packaging materials). In general, goods sold at a retailer are wrapped in one of packaging sheets of the retailer and then handed to the customer. The packaging sheet database 60 has records (packaging sheet data 60′) each relates to a packaging sheet. Note that the packaging sheet data corresponds to packaging material data. FIG. 3 is a schematic view illustrating the structure of the packaging sheet database 60. As shown in FIG. 3, each packaging sheet data 60′ has a packaging sheet code field 61, an image field 62, a retailer field 63, a charge field 64, and a payment mode field 65.

The packaging sheet code field 61 stores a packaging sheet code uniquely related to a packaging sheet. The image field 62 stores the image data of the packaging sheet. The retailer field 63 stores the name of the retailer providing the packaging sheet. The charge field 64 stores the value of charge to be billed to the customer for the packaging sheet. The payment mode field 65 stores the names of credit cards or so-called house cards which are acceptable at the retailer (63). For example, the packaging sheet data 60′ whose packaging sheet code (61) is “L01,” stores “V credit card, . . . , Store A card” in the payment mode field 65. This “Store A card” is a house card.

It should be noted that the aforementioned image (62) and the retailer (63) correspond to information indicating a packaging material and retailer information, respectively.

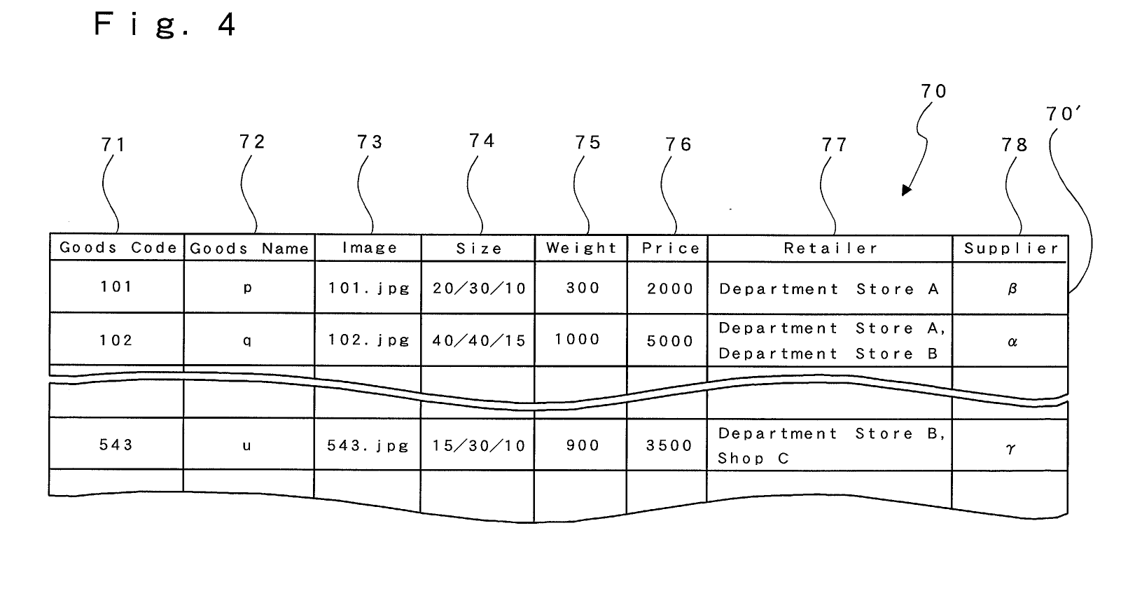

FIG. 4 is a schematic view illustrating the structure of the goods database 70. The goods database 70 has records (goods data 70′) each relating to each of goods available at the retailer. The goods data 70′ has a goods code field 71, a goods name field 72, an image field 73, a size field 74, a weight field 75, a price field 76, a retailer field 77, and a supplier field 78. Note that the goods name (72), the image (73), and the price (76) correspond to goods description information.

The goods code field 71 stores a code of goods uniquely related to the goods. The goods name field 72 stores the name of the goods. The image field 73 stores image data of the goods. The size field 74 stores the size of the goods. For example, the goods data 70′ having a goods code “101” (71) stores “20/30/10” in the size field 74. When the goods are supposed to have a rectangular shape, this “20/30/10” means that the goods have three edges of 20 cm, 30 cm and 10 cm.

The weight field 75 stores the weight of the goods by the gram. The price field 76 stores the price of the goods. The retailer field 77 stores names of all retailers where the goods are actually available. The supplier field 78 stores the name of manufacturers or suppliers from which the wholesaler purchases the goods.

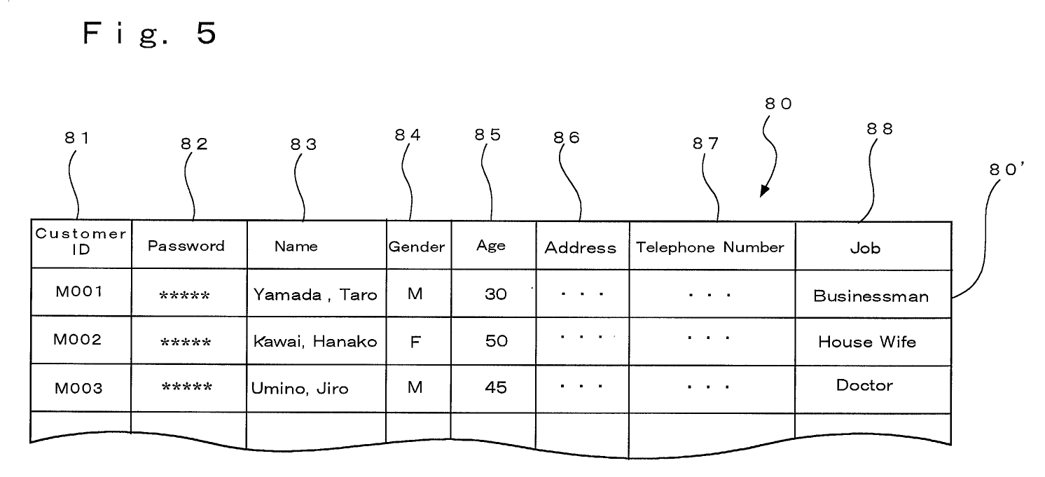

FIG. 5 is a schematic view showing the structure of the customer database 80. The customer database 80 has records (customer data 80′) each corresponding to each customer or member of the Web site that the server machine 10 provides. The customer data 80′ has a customer ID field 81, a password field 82, a name field 83, a gender field 84, an age field 85, an address field 86, a telephone number field 87, and a job field 88.

The customer ID field 81 stores a customer ID (customer information) uniquely related to the customer. The password field 82 stores a password set by the customer. The name field 83 stores the name of the customer. The gender field 84 stores a character code, “M” or “F” (male or female), indicating the gender of the customer. The age field 85 stores the age of the customer. The address field 86 stores the address of the customer. The telephone number field 87 stores the telephone number of the customer. The job field 88 stores a character string indicating the job of the customer.

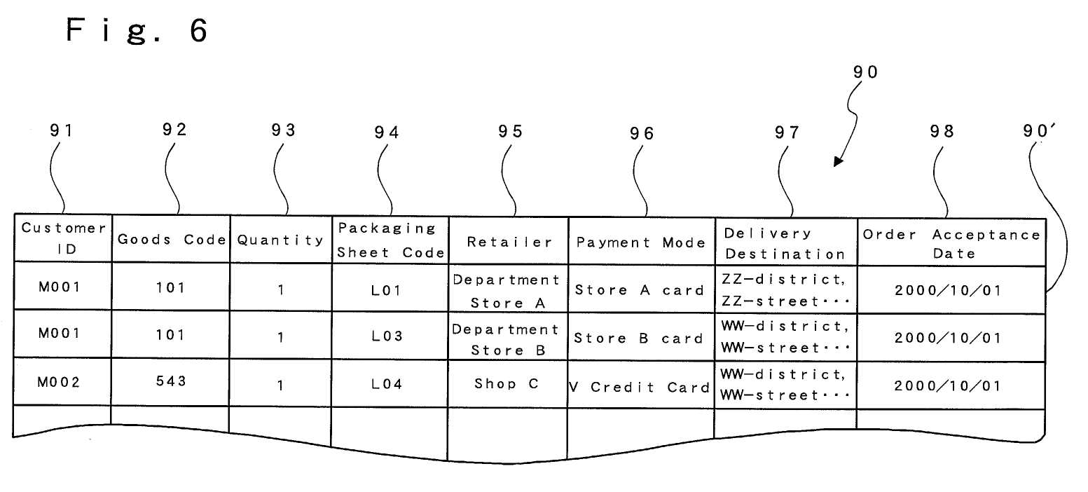

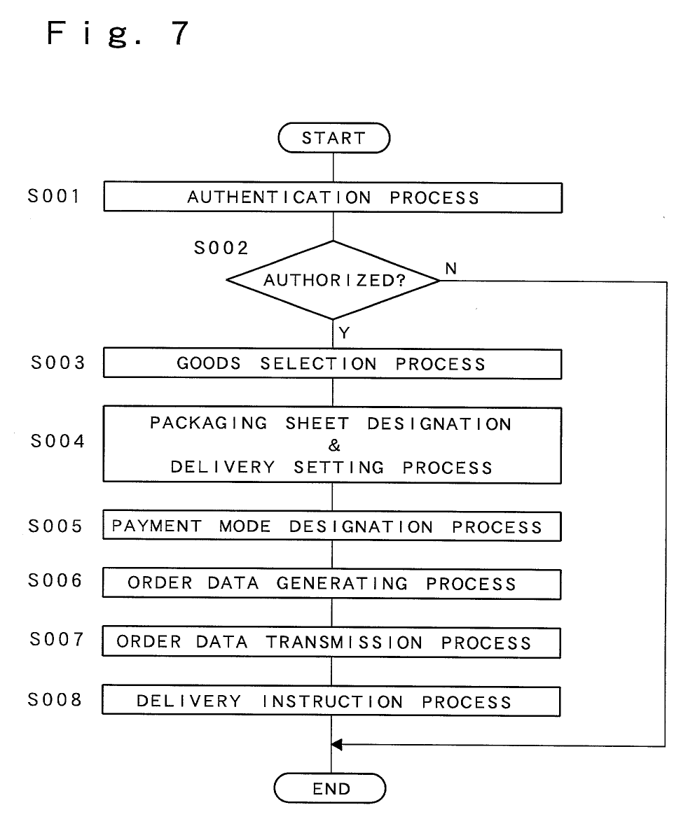

FIG. 6 is a schematic view showing the structure of the order database 90. The order database 90 has records (order data 90′) which are generated by the goods sale process (FIG. 7), described later, and which are stored in the order in which the records are generated. Each order data 90′ has a customer ID field 91, a goods code field 92, a quantity field 93, a packaging sheet code field 94, a retailer field 95, a payment mode field 96, a delivery destination field 97, and an order acceptance date field 98.

The customer ID field 91 stores the customer ID of a customer who has bought the goods. The goods code field 92 stores the goods code of the goods that the customer has bought. The quantity field 93 stores the quantity of the goods that the customer has bought.

The packaging sheet code field 94 stores the packaging sheet code of the packaging sheet that the customer has designated for wrapping the goods. The retailer field 95 stores the name of the retailer that provides the packaging sheet related to the packaging sheet code (94). The payment mode field 96 stores the payment mode that the customer has designated. The delivery destination field 97 stores a character string indicating the address and name that have been designated by the customer as the delivery destination of the goods. The order acceptance date field 98 stores the date when the order data 90′ has been generated.

<Goods Sale Process>

The processing performed by the server machine 10 to sell goods to a customer will be explained below with reference to the flowchart of FIG. 7. The flowchart of FIG. 7 is initiated when the customer operates the customer machine 20 to access the Web site provided by the server machine 10.

First, in S001, the server machine 10 controls the customer machine 20 to display a Web page for authentication. Then, the customer operates the customer machine 20 to enter the customer ID and password in the input field of the Web page. Then, the server machine 10 receives the entered customer ID and password.

In S002, the server machine 10 identifies the customer data 80′ that includes the customer ID received in S001 to compare the password (82) of the identified customer data 80′ with the password received in S001, thereby branching the process in accordance with the result of the comparison. That is, if both passwords match, the server machine 10 determines that the customer has entered an authorized password and then advances the process to S003. In contrast, if the passwords do not match, the server machine 10 determines that the customer has not entered an authorized password and then terminates the processing.

In S003, the server machine 10 executes the goods selection process. That is, the server machine 10 controls the customer machine 20 to display a Web page (offering data) so that the customer can select goods that the customer wants to buy in accordance with the Web page displayed thereon.

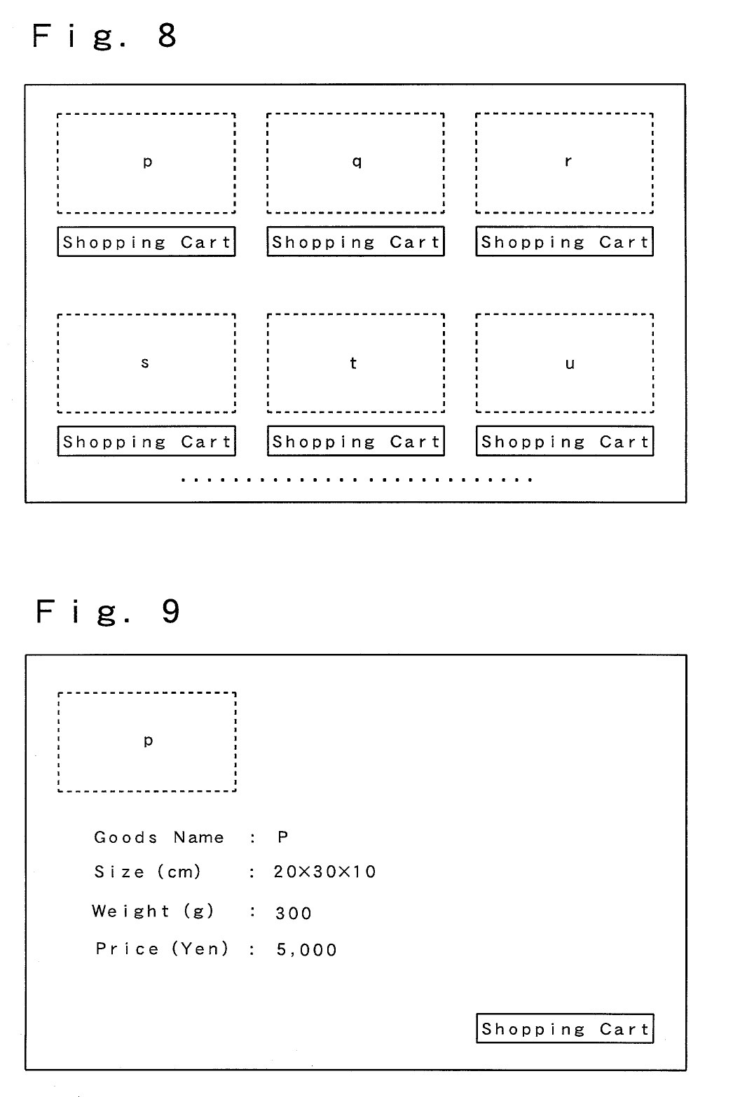

The goods selection process will be explained more specifically below. First, the server machine 10 displays a goods list page on the customer machine 20. FIG. 8 is a schematic view showing a goods list page. Note although not shown in detail in FIG. 8, the goods list page displays images (73) contained in the goods data 70′ each corresponding to each of the goods (p)-(u) in conjunction with the goods name (72) and the price (76).

As shown in FIG. 8, a “shopping cart” button is displayed immediately below each image (p)-(u) appearing in FIG. 8. Note that a storage area for each customer corresponding to each “shopping cart” is assigned on the memory 13 of the server machine 10. This storage area is hereinafter referred to as a virtual shopping cart. When a customer wants to buy goods, the customer operates the customer machine 20 and clicks the “shopping cart” button corresponding to the goods. Then, the server machine 10 stores the goods code corresponding to the clicked image in the virtual shopping cart assigned for the customer.

It should be noted when the customer clicks the desired image among the images (p)-(u), displayed in FIG. 8, through the operation of the customer machine 20, the server machine 10 displays a goods information page on the customer machine 20. For example, when the customer has clicked the image (p) in FIG. 8, the goods information page shown in FIG. 9 is displayed.

This goods information page of FIG. 9 includes an image (73) contained in the goods data 70′ corresponding to the goods (p). In addition, this goods information page includes spaces for displaying “Goods Name,” “Size,” “Weight” and “Price.” In each of the spaces the information in the fields 72, 74, 75, 76 of the goods data 70′ corresponding to the goods (p) is displayed.

Furthermore, the goods information page includes a “shopping cart” button. When the customer is going to buy the goods, the customer clicks the “shopping cart” button through the operation of the customer machine 20. Then, the server machine 10 stores the goods code of the goods corresponding to this goods information page in the virtual shopping cart.

When the “shopping cart” button of FIGS. 8 or 9 is clicked, the server machine 10 stores the goods code into the virtual shopping cart as described above and displays a shopping cart page on the customer machine 20. FIG. 10 is a schematic view showing the shopping cart page. In FIG. 10, a table having the columns of “Goods Name,” “Unit Price,” “Quantity,” and “Total” is displayed. The columns of “Goods Name” and “Unit Price” of FIG. 10 contain the information in the goods name field 72 and the price field 76 of the goods data 70′ that includes the goods code stored in the virtual shopping cart.

Shown in FIG. 10 is an example having only one goods code “101” in the virtual shopping cart. That is, FIG. 10 shows the goods name (72) and the price (76) of the goods data 70′ whose goods code is “101” in the columns of the “Goods Name” and the “Unit Price”, with “1” being contained in the “Quantity” column. Note when a virtual shopping cart includes the same goods codes, the quantity of the goods codes is displayed in the “Quantity” column of FIG. 10. In addition, when the virtual shopping cart contains various goods codes, for each of goods to which the goods code corresponds, a table of FIG. 10 is displayed.

In the “Total” column of FIG. 10, the product of the value indicated in the “Unit Price” column and the value indicated in the “Quantity” column, is displayed.

Furthermore, FIG. 10 includes “Shopping Continued” and “Delivery Setting” buttons. When the customer clicks the “Shopping Continued” button through the operation of the customer machine 20, the server machine 10 displays the goods list page of FIG. 8 again on the customer machine 20. On the other hand, when the customer clicks the “Delivery Setting” button through the operation of the customer machine 20, the server machine 10 advances the processing from S003 to S004.

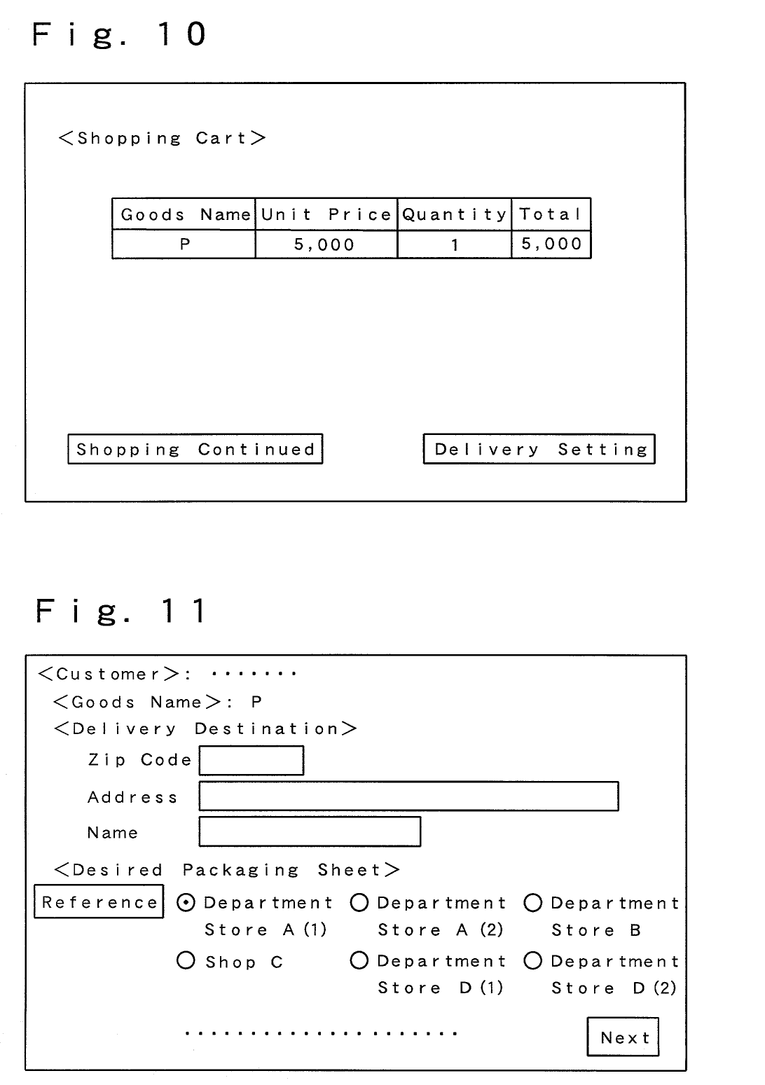

In S004, the server machine 10 displays a delivery setting page on the customer machine 20. FIG. 11 is a schematic view showing the delivery setting page. The delivery setting page includes the spaces of “Customer,” “Goods Name,” “Delivery Destination,” and “Desired Packaging Sheet.”

In the “customer” space, the name (83) of the customer data 80′ containing the customer ID that has been entered in S001, is displayed. In the “goods name” space, the goods name (72) of the goods data 70′ containing the goods codes that have been stored in the virtual shopping cart, is displayed. Note when the virtual shopping cart contains more than one type of goods, all goods names are displayed. In addition, when the goods are more than one in number, the name of which is displayed with being followed by the number (quantity) of the goods.

The “delivery destination” space includes the entry fields of “Zip Code,” “Address,” and “Name.” The customer enters corresponding character strings in these entry fields respectively through the operation of the customer machine 20.

In the “Desired Packaging Sheet” space, radio buttons each corresponding to “Department Store A(1),” “Department Store A(2),” “Department Store B,” “Shop C,” “Department Store D(1),” and “Department Store D(2),” are displayed. In addition, “reference” and “next” buttons are also displayed. Each of the radio buttons corresponds to a packaging sheet for wrapping the goods. Through the operation of the customer machine 20, the customer clicks a radio button corresponding to the desired packaging sheet for designating. When the “Reference” button is clicked through the operation of the customer machine 20, the server machine 10 displays a packaging sheet list page on the customer machine 20. FIG. 12 is a schematic view showing the packaging sheet list page.

In the packaging sheet list page of FIG. 12, packaging sheet images are displayed. Each of these images, “A(1),” “A(2),” “B,” “C,” “D(1),” and “D(2),” comes from the image (62) of each piece of the packaging sheet data 60′ whose packaging sheet code (61) is “L01”-“L06.” Through the operation of the customer machine 20, the customer clicks a desired image among the images displayed thereon to designate the packaging sheet. Then, the server machine 10 displays the delivery setting page of FIG. 11 again on the customer machine 20. In this delivery setting page, the radio button corresponding to the packaging sheet designated by the customer in FIG. 12, is turned on.

Then, through the operation of the customer machine 20, when the “Next” button in the delivery setting page of FIG. 11 is clicked, the server machine 10 advances the processing to S005.

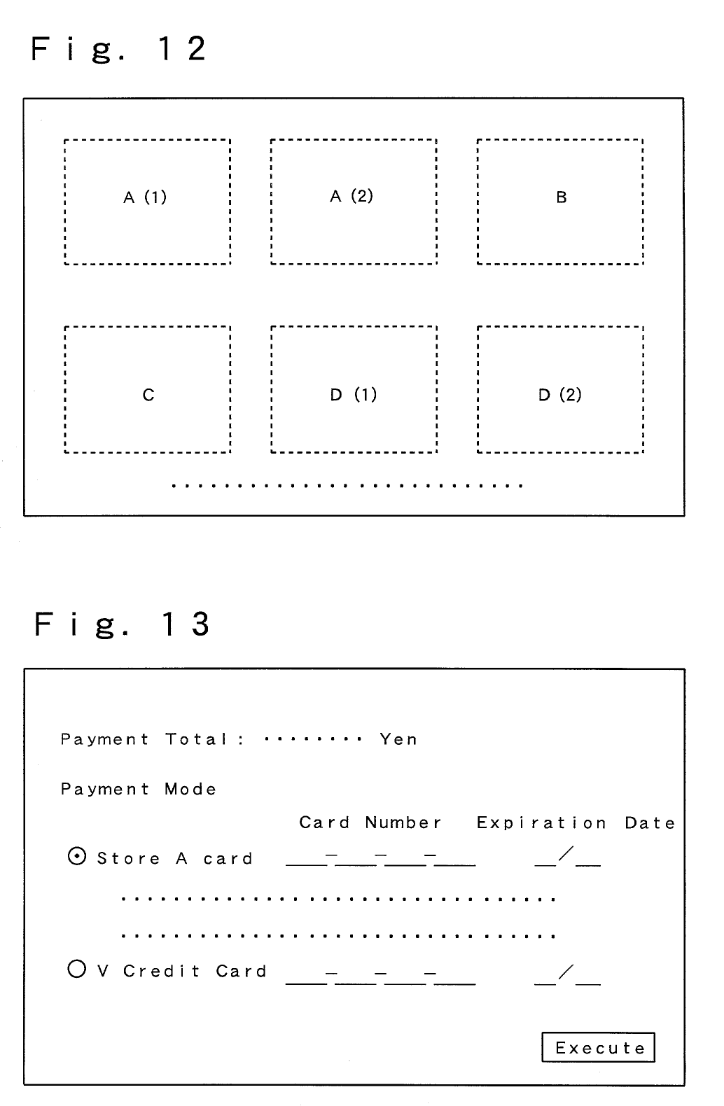

In S005, the server machine 10 displays a payment mode designation page on the customer machine 20. FIG. 13 is a schematic view showing the payment mode designation page. The payment mode designation page includes the items of “Payment Total” and “Payment Mode” as well as an “Execute” button.

In the “Payment Total” item, the amount of money that the customer has to pay, is displayed. This amount of money has been obtained by adding the charge (64) of the packaging sheet data 60′ corresponding with the packaging sheet designated in S004 to the sum of the price (76) of the goods data 70′ whose goods code is in the virtual shopping cart, and then by multiplying to the resulting total sum with the consumption tax.

In the “payment mode” item, the names of the cards available for the payment and the radio buttons corresponding to the cards respectively. In this “payment mode” item, only the names of the cards stored in the payment mode field 65 of the packaging sheet data 60′ corresponding to the packaging sheet designated in S004, are displayed.

Then, through the operation of the customer machine 20, the customer clicks the radio button corresponding to the one that the customer wants to use among the displayed names of the cards. In addition, through the operation of the customer machine 20, the customer enters the customer's own card number and the expiration date respectively in the entry fields of “Card Number” and “Expiration Date” corresponding to the radio button clicked.

Thereafter, through the operation of the customer machine 20, the “Execute” button being clicked, the server machine 10 obtains the entered card number and expiration date, and controls the customer machine 20 to display a Web page notifying that the deal has been done.

In S006, the server machine 10 generates the order data 90′. In the customer ID field 91 of the order data 90′ the customer ID obtained in S001, is stored. Note that the server machine 10 generates order data 90′ for each type of the goods code stored in the virtual shopping cart. That is, when more than one type of goods code are stored in the virtual shopping cart, a plurality of pieces of order data 90′ are generated.

In the quantity field 93 of the order data 90′, the number of the same type of the goods code in the virtual shopping cart, is stored. In the packaging sheet code field 94, the packaging sheet code corresponding to the packaging sheet designated in S004, is stored. In the retailer field 95, the retailer (63) of the packaging sheet data 60′ corresponding to the packaging sheet designated in S004, is stored.

In the payment mode field 96 of the order data 90′, the name of the card designated by the customer in S005, is stored. In the delivery destination field 97, the delivery destination entered by the customer in S004, is stored. In the order acceptance date field 98, stored is the date acquired by the server machine 10 when the processing of S006 has been initiated.

Then, the server machine 10 deletes all the goods codes which are stored in the virtual shopping cart assigned for the corresponding customer, and then advances the processing to S007.

In S007, the server machine 10 sends the order data 90′ generated in S006 to the retailer machine 30. That is, the server machine 10 identifies the retailer stored in the retailer field 95 of the order data 90′ prepared in S006 and then sends the order data 90′ to the retailer machine 30 of the identified retailer. For example, the order data 90′ is sent as an encrypted mail. Then the retailer machine 30 receives the order data 90′, and settles the account of the customer whose customer ID (91) is included in the received order data 90′ in accordance with its payment mode (96).

In S008, the server machine 10 generates the delivery instruction data including the information necessary for delivery, and sends the data to the freight agency machine 50. For example, the delivery instruction data is sent as an encrypted mail.

More specifically, the server machine 10 identifies the customer data 80′ whose customer ID (81) is the same as customer ID (91) of the order data 90′ generated in S006 to acquire the name (83), address (86), and the telephone number (87) of the identified customer data 80′. Furthermore, the server machine 10 identifies the goods data 70′ whose goods code (71) is the same as goods code (92) of the order data 90′ generated in S006 to acquire the supplier (78) of the identified goods data 70′.

Then, the server machine 10 generates the delivery instruction data that contains the acquired name (83), address (86), telephone number (87), and the supplier (78), as well as the goods code (92), the quantity (93), the packaging sheet code (94), and the delivery destination (97) of the order data 90′ generated in S006. In addition, the server machine 10 sends the generated delivery instruction data to the freight agency machine 50 and then terminates the processing. The data that contains the goods code (92), the quantity (93), and the packaging sheet code (94) of the delivery instruction data may be sent to the manufacturer machine 40 corresponding to the supplier (78).

The freight agency machine 50 receives the delivery instruction data, and the freight agency goes to the manufacturer or the supplier (78) to receive the aforementioned quantity (93) of goods corresponding to the goods code (92). In addition, the freight agency wraps the received goods in the packaging sheet corresponding to the packaging sheet code (94), and then delivers the goods to the delivery destination (97).

As described above, the Web site provided by the aforementioned server machine 10 makes it possible for the customer, without going to the retailer, to send the gift that is wrapped in the packaging sheet of the retailer desired by the customer to the destination. Suppose the customer wants to send gifts, which are sold by different retailers, to more than one destination. In this case, use of the Web site makes it possible for the customer to send the gifts easily, each of which is wrapped in a packaging sheet of each desired retailer, to each corresponding destination without being bothered by placing individual orders to each retailer.

It should be noted that the customer selects goods in S003 (FIG. 7), designates a packaging sheet, enters a delivery destination, and then designates a payment mode. These processes correspond to receiving the designation data that includes the goods designation information, the packaging material designation information, the delivery destination information, and the payment mode designation information.

<Provision of Statistics>

In addition, in response to a request from each retailer machine 30, the server machine 10 gathers statistics in accordance with the order database 90 and then sends the gathered statistics to the retailer machine 30. Note that a clerk of a retailer operates the retailer machine 30 to access the Web site provided by the server machine 10 for retailers to initiate the provision of the statistics. The retailer accessing the Web site is hereinafter referred to as the target retailer.

After the process has been initiated, the server machine 10 searches the order database 90 (FIG. 6) to acquire the order data (90′) that includes the name of the target retailer in the retailer field 95. In addition, from the acquired order data (90′), the server machine 10 extracts the order data (90′) that does not include the name of the target retailer in the retailer field 77 of the goods data 70′ corresponding to the goods code (92).

Then, from the extracted order data (90′), the server machine 10 groups the order data (90′) that has the same goods code (92). Furthermore, with the order data (90) of each group, the server machine 10 calculates the total quantity (93) of each group, thereby acquiring the total quantity corresponding to each goods code as the quantity of sales.

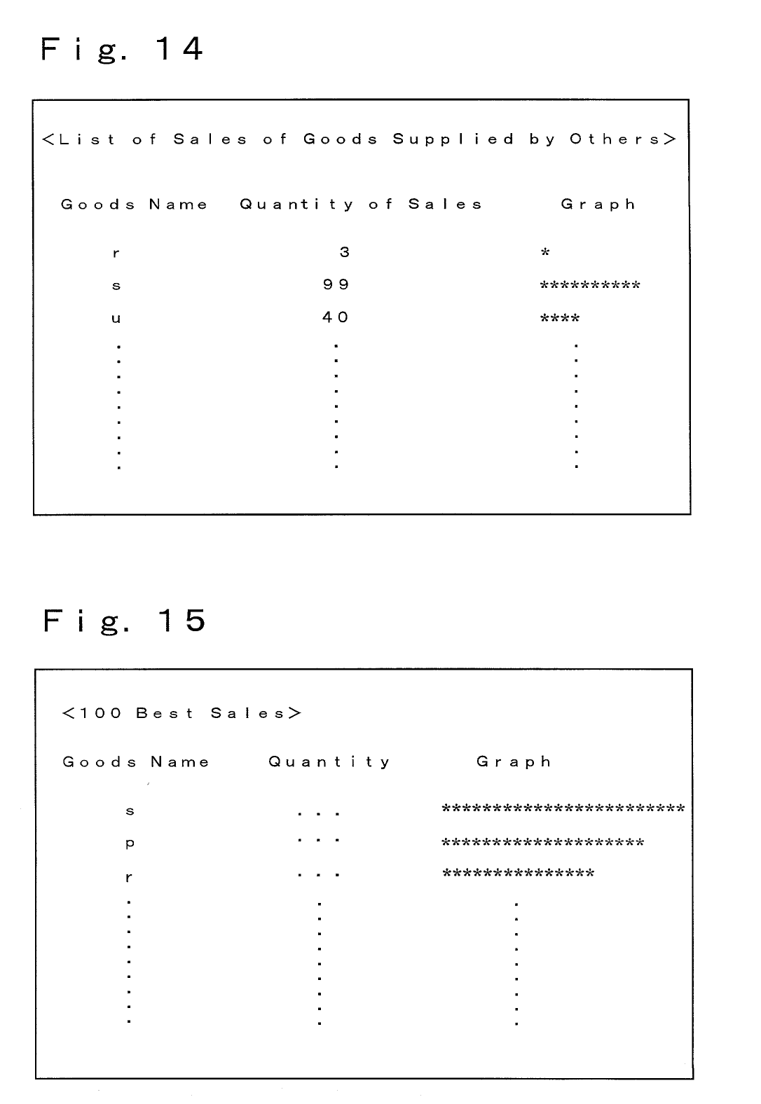

Then the server machine 10 generates a statistics Web page, based on the goods name (72) of the goods data 70′ including the goods code and the quantity of sales corresponding to the goods code. The statistics Web page is displayed by the retailer machine 30 of the target retailer. FIG. 14 is a schematic view of the statistics Web page showing <List of Sales Supplied by Others>. The statistics Web page includes the columns of “Goods Name,” “Quantity of Sales,” and “Graph.” In the graph, the length of a character string comprising “*” represents the quantity of sales.

The clerk of the target retailer can browse the statistics Web page to obtain the name of the goods and the quantity of sales of the goods that have been sold through the retailer but originally not on sale at the retailer.

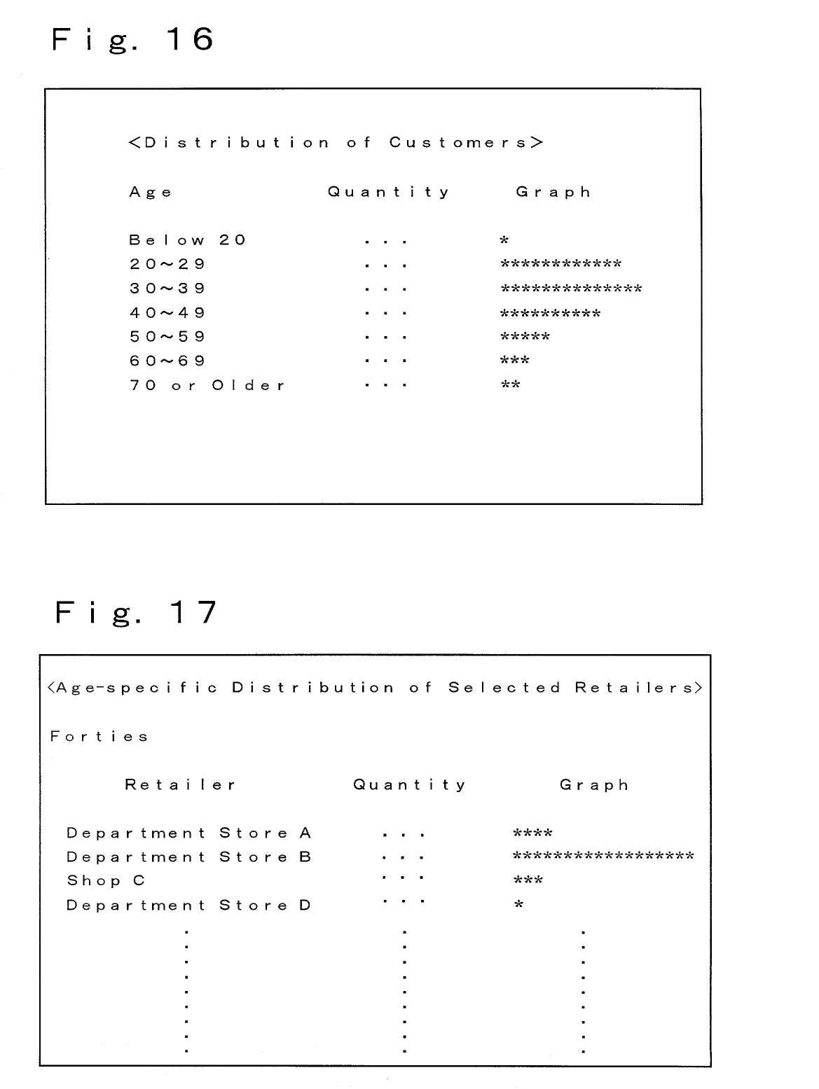

In addition to the statistics, the server machine 10 may provide the retailer machine 30 with statistics on the customers who have bought goods and on the sales situation of each retailer as the statistics Web pages shown in FIGS. 15-17. FIG. 15 is a schematic view of a statistics Web page showing <100 Best Sales>. FIG. 16 is a schematic view of a statistics Web page showing <Distribution of Customers>. FIG. 17 is a schematic view of a statistics Web page showing <Age-Specific Distribution of Selected Retailers>.

According to the method for selling goods of the aforementioned present invention, it is possible for customers to buy the desired goods wrapped in a packaging material of the desired retailer without actually going to the retailer. Therefore the method provides an improved convenience for the customer to buy goods.

In addition, the retailer can have information on the goods that have been sold through the retailer but originally not on sale at the retailer. It helps the retailer to plan the selection of goods.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. A method for selling goods, comprising:
a step of storing packaging material data which includes information indicating a packaging material and retailer information indicating a retailer providing the packaging material, as well as goods data which includes goods description information describing goods for sale;
a step of sending offering data which includes the goods description information in said goods data and the information indicating a packaging material in said packaging material data to a customer;
a step of receiving designation data which includes goods designation information designating goods the customer desires to buy and packaging material designation information designating a packaging material selected by the customer;
a step of specifying retailer information corresponding to the packaging material indicated by the packaging material designation information in the designation data received in said receiving step, based on said packaging material data; and
a step of generating order data which includes the specified retailer information, customer information indicating the customer, and the goods designation information in the designation data received in said receiving step.

2. A method for selling goods using a computer having storage, comprising:
a step of storing packaging material data which includes information indicating a packaging material and retailer information indicating a retailer providing the packaging material, as well as goods data which includes goods description information describing goods for sale into the storage;
a step of outputting offering data which includes the goods description information in said goods data and the information indicating a packaging material in said packaging material data to a customer;
a step of receiving designation data which includes goods designation information designating goods the customer desires to buy and packaging material designation information designating a packaging material selected by the customer;
a step of specifying retailer information corresponding to the packaging material indicated by the packaging material designation information in the designation data received in said receiving step, based on said packaging material data; and
a step of generating order data which includes the specified retailer information, customer information indicating the customer, and the goods designation information in the designation data received in said step of receiving.

3. A method for selling goods using a server computer having storage and connectable to first client computers each operated by a retailer and to a second client computer operated by a customer, comprising:
a step of storing packaging material data which includes information indicating a packaging material and retailer information indicating a retailer providing the packaging material, as well as goods data which includes goods description information describing goods for sale into the storage;
a step of sending offering data which includes the goods description information in said goods data and the information indicating a packaging material in said packaging material data to the second client computer;
a step of receiving designation data which includes goods designation information designating goods the customer desires to buy and packaging material designation information designating a packaging material selected by the customer from the second client computer;
a step of specifying retailer information corresponding to the packaging material indicated by the packaging material designation information in the designation data received in said receiving step, based on said packaging material data; and
a step of generating order data which includes the specified retailer information, customer information indicating the customer, and the goods designation information in the designation data received in said receiving step.

4. The method for selling goods according to claim 3, wherein
said designation data further includes delivery destination information for specifying a delivery destination of the goods, and
said order data further includes the delivery destination information in the designation data.

5. The method for selling goods according to claim 3, further comprising a step of transmitting the generated order data to the first client computer of the retailer indicated by the retailer information in the order data.

6. The method for selling goods according to claim 3, wherein
said packaging material data further includes payment mode information indicating one or more payment modes provided by the retailer indicated by the retailer information in the packaging material data,
said offering data further includes the payment mode information in the packaging material data,
said designation data further includes payment mode designation information designating a payment mode selected by the customer based on the payment mode information in the offering data, and
said order data further includes the payment mode designation information in the designation data.

7. The method for selling goods according to claim 3, wherein
said goods data includes retailer information indicating every retailer usually selling corresponding goods, and
the method further comprising:
a step of extracting order data whose retailer information indicates a retailer different from that indicated by the retailer information in the goods data corresponding to goods designation information in the same order data, and
a step of gathering statistics including the retailer information and goods designation information in the extracted order data.

8. The method for selling goods according to claim 3, wherein
said packaging material data further includes charge information indicating a charge related to a corresponding packaging material,
the goods description information in said goods data includes a price of the goods, and
the method further comprising:
a step of obtaining the price of the goods indicated by the goods designation information in the designation data based on the goods description information in the goods data, and the charge related to the packaging material indicated by the packaging material designation information in the designation data based on the packaging material data; and
a step of calculating the total amount should be paid by the customer, based on the price and the charge obtained in the obtaining step.

9. An apparatus for selling goods, comprising:
a server computer connected to first client computers each operated by a retailer and to a second client computer operated by a customer;
a first storage medium storing packaging material data which includes information indicating a packaging material and retailer information indicating a retailer providing the packaging material;
a second storage medium storing goods data which includes goods description information describing goods for sale; and
a third storage medium storing a server program which controls the server computer to execute:
a step of sending offering data which includes the goods description information in said goods data and the information indicating a packaging material in said packaging material data to the second client computer,
a step of receiving designation data which includes goods designation information designating goods the customer desires to buy and packaging material designation information designating a packaging material selected by the customer from the second client computer,
a step of specifying retailer information corresponding to the packaging material indicated by the packaging material designation information in the designation data received in said receiving step, based on said packaging material data, and
a step of generating order data which includes the specified retailer information, customer information indicating the customer, and the goods designation information in the designation data received in said receiving step.

10. A computer readable storage medium which is readable by a computer connectable to first client computers each operated by a retailer and to a second client computer operated by a customer, storing:
packaging material data which includes information indicating a packaging material and retailer information indicating a retailer providing the packaging material;
goods data which includes goods description information describing goods for sale; and
a server program which controls the computer to execute:
a step of sending offering data which includes the goods description information in said goods data and the information indicating a packaging material in said packaging material data to the second computer,
a step of receiving designation data which includes goods designation information designating goods the customer desires to buy and packaging material designation information designating a packaging material selected by the customer from the second client computer,
a step of specifying retailer information corresponding to the packaging material indicated by the packaging material designation information in the designation data received in said receiving step, based on said packaging material data, and
a step of generating order data which includes the specified retailer information, customer information indicating the customer, and the goods designation information in the designation data received in said receiving step.

11. A method for selling goods using a client computer connectable to an apparatus for selling goods, comprising:
a step of acquiring goods description information describing goods for sale and information indicating a packaging material which have sent by the apparatus for selling goods;
a step of designating the goods and the packaging material both of which the customer desires to get; and
a step of ordering by sending goods designation information indicating the designated goods and packaging material designation information indicating the designated packaging material to the apparatus for selling goods.

12. A computer program product, comprising:
instructions for storing packaging material data which includes information indicating a packaging material and retailer information indicating a retailer providing the packaging material, as well as goods data which includes goods description information describing goods for sale;
instructions for outputting offering data which includes the goods description information in said goods data and the information indicating a packaging material in said packaging material data to a customer;
instructions for receiving designation data which includes goods designation information designating goods the customer desires to buy and packaging material designation information designating a packaging material selected by the customer;
instructions for specifying retailer information corresponding to the packaging material indicated by the packaging material designation information in the designation data received in accordance with the receiving instructions, based on said packaging material data; and
instructions for generating order data which includes the specified retailer information, customer information indicating the customer, and the goods designation information in the designation data received in accordance with the receiving instructions.
